(19) United States
(12) Patent Application Publication
(10) Pub. No.: US 2023/0176004 A1
(43) Pub. Date: Jun. 8, 2023

(54) DOUBLE JUNCTION REFERENCE ELECTRODE

(71) Applicant: ENGENIOUSAG LLC, Ames, IA (US)

(72) Inventors: Liang Dong, Ames, IA (US); Xinran Wang, Ames, IA (US)

(21) Appl. No.: 18/074,762

(22) Filed: Dec. 5, 2022

Related U.S. Application Data
(60) Provisional application No. 63/287,027, filed on Dec. 7, 2021.

(51) Int. Cl. G01N 27/401; G01N 27/30; G01N 27/40

(52) U.S. Cl. CPC G01N 27/401; G01N 27/301; G01N 27/40

(57) ABSTRACT

Provided herein is technology relating to electrochemical detection of analytes and particularly, but not exclusively, to a double junction reference electrode, methods of using a double junction reference electrode, handheld or robotically manipulable apparatuses comprising a double junction reference electrode, and systems comprising a double junction reference electrode.

### DOUBLE JUNCTION REFERENCE ELECTRODE

This application claims priority to United States provisional patent application Ser. No. 63/287,027, filed Dec. 7, 2021, which is incorporated herein by reference in its entirety.

### STATEMENT REGARDING FEDERALLY SPONSORED RESEARCH OR DEVELOPMENT

This invention was made with government support under award number 1914251 awarded by the National Science Foundation and award number 2019-33610-29771 awarded by the Department of Agriculture. The government has certain rights in the invention.

### FIELD

Provided herein is technology relating to electrochemical detection of analytes and particularly, but not exclusively, to a double junction reference electrode, methods of using a double junction reference electrode, handheld apparatuses comprising a double junction reference electrode, and systems comprising a double junction reference electrode.

### BACKGROUND

Measurement of analytes is often performed using electrochemical methods in which a potential or a current is measured between a working electrode and a reference electrode. A reference electrode typically comprises half-cell components that have well-defined activities and that are stable as a function of time and temperature. Further, a double-junction design reduces deposition of reference electrode materials on the working electrode and contamination of sample with electrode ions by placing a second solution between the reference half-cell and the measurement solution.

A conventional double-junction reference electrode, such as a silver/silver chloride (Ag/AgCl) double-junction reference electrode, typically has an inner chamber and an outer chamber. The inner chamber comprises an inner filling solution and has a first liquid junction through a porous frit with an intermediary salt bridge provided by the outer chamber comprising an outer filling solution. The outer chamber has a second liquid junction through a second porous frit to an external sample solution to be tested with the electrode.

The internal filling solution is typically a KCl solution and the outer filling solution is chosen to avoid contamination of the solution to be tested with the target ion or any other ion or substance that would interfere with testing and to minimize the effects of the liquid junction potential. Lithium acetate (LiCH₃COO), KCl, and potassium nitrate (KNO₃) are often selected as the outer filling solution to provide the intermediary salt bridge due to their similar mobilities of ions. U.S. Pat. Nos. 4,390,406 and 4,282,081; and Int'l Pat. App. Pub. Nos. WO1993004360A1 and WO2014204293A1 provide examples of conventional electrodes.

Several liquid-state double junction reference electrodes are commercially available (e.g., HI5414 from HANNA Instruments and 4210N68 from Thermo Scientific Orion). These commercial double junction reference electrodes exhibit good performance in terms of stability, lifetime, response time, and reproducibility; however, conventional double junction reference electrodes are expensive ($150-300), fragile, and relatively bulky, which hinder system integration and massive manufacturing. Accordingly, improved double junction reference electrode technologies are needed.

### SUMMARY

Conventional double junction reference electrodes generally have large dimensions and are not suitable for inserting into objects for in situ measurements. Further, conventional double junction reference electrodes are often designed with a chemically treated silver wire that hinders integration of the double junction reference electrode with a sensing element and other electronics. Moreover, conventional double junction reference electrodes are designed to operate as a standalone unit having a single sensing element, and thus incorporating multiple sensing elements into conventional designs of double junction reference electrodes, e.g., for performing multiple simultaneous measurements in multiple samples, is difficult or not practical.

Accordingly, provided herein is a technology relating to a double junction reference electrode, methods of using a double junction reference electrode, handheld apparatuses comprising a double junction reference electrode, and systems comprising a double junction reference electrode. In some embodiments, the technology described herein provides a double junction reference electrode that allows a sensing element to be inserted into an object for in-situ measurement of an analyte present in the object. Further, in some embodiments, the double junction reference electrode is integrated with onboard electronics, e.g., both for scaling and for miniaturization. And, in some embodiments, the technology provides a double junction reference electrode that may be used to provide a device comprising multiple double junction reference electrodes, e.g., for parallel and simultaneous testing of multiple samples.

The technology provides several advantages relative to conventional technologies. For example, embodiments of the technology described herein comprise a thin hollow tube pulled from an outer electrolyte chamber to provide a reference probe that is structured to be inserted into a small object, thus providing a reference potential inside the object for sensing. Further, embodiments comprise two chambers of the double junction reference electrodes that are placed horizontally side by side on the surface of a substrate. Accordingly, the reference electrode is easily integrated with other electronics on the same substrate. And, embodiments provide multiple reference probe designs in which a plurality of thin hollow tubes is pulled from an outer electrolyte chamber to provide an array of reference probes and/or double junction reference electrodes. The multiple reference electrodes find use in some embodiments for simultaneously providing multiple separate measurement environments or target objects with a reference potential.

Accordingly, in some embodiments, the technology provides a double junction reference electrode comprising a substrate; and a housing attached to the substrate, the housing comprising a first chamber; an inner wall comprising a first frit; and a second chamber comprising a hollow reference probe structure comprising a second frit. In some embodiments, the substrate further comprises a planar electrode on a first surface of the substrate positioned within the first chamber. In some embodiments, the planar electrode is a silver/silver chloride planar electrode. In some embodiments, the first chamber comprises a first electrolyte in electrical communication with the planar electrode. In some embodiments, the second chamber and reference probe comprise a second electrolyte and the first frit allows ionic conductivity between the first electrolyte and the second electrolyte. In some embodiments, the first electrolyte is a gel electrolyte. In some embodiments, the second electrolyte is a gel electrolyte. In some embodiments, the first electrolyte is a liquid-state electrolyte. In some embodiments, the second electrolyte is a liquid-state electrolyte. In some embodiments, the second frit allows ionic conductivity between the second electrolyte and a sample contacting the reference probe and second frit. In some embodiments, the reference probe further comprising an analyte sensing element. In some embodiments, the analyte sensing element is a nitrate sensing element. However, the technology is not limited to sensing nitrate and embodiments provide that the analyte sensing element may be a sensing element for other ions or molecules (e.g., phosphate, sulphate, calcium, magnesium, zinc, copper, molybdenum, boron, etc.)

In some embodiments, the substrate comprises a printed circuit board (PCB). The technology is not limited to embodiments in which the substrate comprises a PCB. Accordingly, embodiments comprise a substrate onto which electrodes may be deposited to provide a reference electrode. For example, in some embodiments, the substrate comprises glass, plastic, silicon, and/or quartz.

In some embodiments, the housing is attached to the substrate with an adhesive. In some embodiments, the housing comprises a plastic (e.g., a thermoplastic) or a metal. In some embodiments, the first frit and/or the second frit comprise a plastic (e.g., a thermoplastic) or a metal. In some embodiments, the first frit and/or the second frit comprise pores having a mean pore size of 0.5 μm. In some embodiments, the mean pore size ranges from 0.01 μm to 50 μm (e.g., 0.01, 0.02, 0.05, 0.1, 0.2, 0.5, 1, 2, 5, 10, 20, or 50 gm). In some embodiments, the first electrolyte is an electrolyte solution comprising potassium chloride and saturated with silver chloride. In some embodiments, the second electrolyte is a lithium acetate electrolyte.

In some embodiments, the second chamber comprises a plurality of reference probes and each reference probe comprises a second frit and a sensing element. For example, in some embodiments, the technology provides a double junction reference electrode comprising a substrate; and a housing attached to the substrate, the housing comprising a first chamber; an inner wall comprising a first frit; and a second chamber comprising a plurality of hollow reference probe structures each comprising a second frit. In some embodiments, the substrate further comprises a planar electrode on a first surface of the substrate positioned within the first chamber. In some embodiments, the planar electrode is a silver/silver chloride planar electrode. In some embodiments, the first chamber comprises a first electrolyte in electrical communication with the planar electrode. In some embodiments, the second chamber and each reference probe comprise a second electrolyte and the first frit allows ionic conductivity between the first electrolyte and the second electrolyte. In some embodiments, the first electrolyte is a gel electrolyte. In some embodiments, the second electrolyte is a gel electrolyte. In some embodiments, the first electrolyte is a liquid-state electrolyte. In some embodiments, the second electrolyte is a liquid-state electrolyte. In some embodiments, the second frit allows ionic conductivity between the second electrolyte and a sample contacting the reference probe and second frit. In some embodiments, each reference probe further comprises an analyte sensing element.

In some embodiments, a number of the analyte sensing elements is/are a nitrate sensing element(s). However, the technology is not limited to sensing nitrate and embodiments provide that a number of the analyte sensing elements may be sensing elements for other ions or molecules (e.g., phosphate, sulphate, calcium, magnesium, zinc, copper, molybdenum, boron, etc.)

In some embodiments, the substrate comprises a printed circuit board (PCB). The technology is not limited to embodiments in which the substrate comprises a PCB. Accordingly, embodiments comprise a substrate onto which electrodes may be deposited to provide a reference electrode. For example, in some embodiments, the substrate comprises glass, plastic, silicon, and/or quartz.

In some embodiments, the housing is attached to the substrate with an adhesive. In some embodiments, the housing comprises a plastic (e.g., a thermoplastic) or a metal. In some embodiments, the first frit and/or each second frit comprise a plastic (e.g., a thermoplastic) or a metal. In some embodiments, the first frit and/or each second frit comprise pores having a mean pore size of 0.5 μm. In some embodiments, the pore size ranges from 0.01 μm to 50 μm (e.g., 0.01, 0.02, 0.05, 0.1, 0.2, 0.5, 1, 2, 5, 10, 20, or 50 μm). In some embodiments, the first electrolyte is an electrolyte solution comprising potassium chloride and saturated with silver chloride. In some embodiments, the second electrolyte is a lithium acetate electrolyte.

Further, in some embodiments, the technology provides an integrated plurality of double junction reference electrodes. For example, in some embodiments, the technology provides an integrated plurality of double junction reference electrodes comprising a substrate; and a housing attached to the substrate, the housing comprising a plurality of first chambers; a plurality of inner walls each comprising a first frit; and a plurality of second chambers each comprising an associated hollow reference probe structure comprising an associated second frit, wherein each inner wall separates one first chamber and one second chamber associated with one another in one double junction reference electrode. In some embodiments, the substrate further comprises a plurality of planar electrodes on a first surface of the substrate and each planar electrode is positioned within one first chamber associated with the planar electrode. In some embodiments, a number of planar electrode(s) is/are a silver/silver chloride planar electrode(s). In some embodiments, each first chamber comprises an associated first electrolyte in electrical communication with each associated planar electrode. In some embodiments, each second chamber and reference probe comprises an associated second electrolyte and each first frit allows ionic conductivity between the first electrolyte of each first chamber associated with the first frit and the second electrolyte of the second chamber associated with the first frit. In some embodiments, the first electrolyte is a gel electrolyte. In some embodiments, the second electrolyte is a gel electrolyte. In some embodiments, the first electrolyte is a liquid-state electrolyte. In some embodiments, the second electrolyte is a liquid-state electrolyte. In some embodiments, each second frit allows ionic conductivity between the associated second electrolyte and a sample contacting a reference probe and a second frit. In some embodiments, each reference probe further comprises an associated analyte sensing element. In some embodiments, a number of analyte sensing element(s) is/are a nitrate sensing element(s). However, the technology is not limited to sensing nitrate and embodiments provide that the analyte sensing element may be a sensing element for other ions or molecules (e.g., phosphate, sulphate, calcium, magnesium, zinc, copper, molybdenum, boron, etc.)

In some embodiments, the substrate comprises a printed circuit board (PCB) and/or a plurality of PCBs. The technology is not limited to embodiments in which the substrate comprises a number of PCBs. Accordingly, embodiments comprise a number of substrates onto which electrodes may be deposited to provide a reference electrode. For example, in some embodiments, each substrate independently comprises glass, plastic, silicon, and/or quartz.

In some embodiments, the housing is attached to the substrate with an adhesive. In some embodiments, the housing comprises a plastic (e.g., a thermoplastic) or a metal. In some embodiments, a first frit and/or a second frit comprise a plastic (e.g., a thermoplastic) or a metal. In some embodiments, a first frit and/or a second frit comprise pores having a mean pore size of 0.5 μm. In some embodiments, the pore size ranges from 0.01 μm to 50 gm (e.g., 0.01, 0.02, 0.05, 0.1, 0.2, 0.5, 1, 2, 5, 10, 20, or 50 μm). In some embodiments, a first electrolyte is an electrolyte solution comprising potassium chloride and saturated with silver chloride. In some embodiments, a second electrolyte is a lithium acetate electrolyte.

Embodiments also provide an integrated analyte measuring device comprising a double junction reference electrode as described herein and/or an integrated plurality of double junction reference electrodes as described herein. In some embodiments, the integrated analyte measuring device further comprises a display. In some embodiments, the integrated analyte measuring device further comprises a wireless communications component. In some embodiments, the integrated analyte measuring device further comprises a consumable working electrode. In some embodiments, the integrated analyte measuring device comprises a case (e.g., a plastic (e.g., a thermoplastic)) shaped to be manipulated by a human hand. In some embodiments, the integrated analyte measuring device comprises a case (e.g., a plastic (e.g., a thermoplastic)) shaped to be manipulated by a robotic manipulator.

The technology further provides embodiments of systems. For example, in some embodiments, the technology provides a system comprising a double junction reference electrode comprising a substrate; and a housing attached to the substrate, the housing comprising a first chamber; an inner wall comprising a first frit; and a second chamber comprising a hollow reference probe structure comprising a second frit; and a computer. In some embodiments, the technology provides a system comprising a double junction reference electrode comprising a substrate; and a housing attached to the substrate, the housing comprising a first chamber; an inner wall comprising a first frit; and a second chamber comprising a hollow reference probe structure comprising a second frit; and a multiwell plate. In some embodiments, the technology provides a system comprising a substrate; and a housing attached to the substrate, the housing comprising a first chamber; an inner wall comprising a first frit; and a second chamber comprising a hollow reference probe structure comprising a second frit; and a wired or wireless communications component. In some embodiments, systems further comprise a remote device in wireless or wired communication with the wired or wireless communications component. In some embodiments, systems further comprise a local device in wired or wireless communication with the wired or wireless communications component. In some embodiments, systems comprise a wireless or wired data logger (e.g., in communication with a wired or wireless communications component of a double junction reference electrode).

In some embodiments, methods provide a method of detecting an analyte. For example, in some embodiments, methods comprise providing a double junction reference electrode comprising a substrate; and a housing attached to the substrate, the housing comprising a first chamber; an inner wall comprising a first frit; and a second chamber comprising a hollow reference probe structure comprising a second frit; and contacting the double junction reference electrode to a sample. In some embodiments, the sample comprises nitrate.

In some embodiments, methods further comprise providing a current or a voltage to an electric circuit in electrical communication with the double junction reference electrode. In some embodiments, methods further comprise providing a signal from the double junction reference electrode to a computer. In some embodiments, methods are performed multiple times for the sample (e.g., 1 time to millions of times (e.g., 1; 2; 5; 10; 20; 50; 100; 200; 500; 1000; 5000; 10,000; 20,000; 50,000; 100,000; 200,000; 500,000; or 1,000,000 times)). In some embodiments, methods are performed multiple times on multiple samples. In some embodiments, methods are performed multiple times in a time period of seconds, minutes, hours, days, weeks, months, or years. In some embodiments, methods further comprise providing a measurement of a positive and/or negative control.

In some embodiments, the sample is a plant, plant part, plant tissue, or a plant fluid; water; soil; manure; or a fruit. In some embodiments, contacting a sample comprises inserting the reference probe into the sample. In some embodiments, contacting a sample comprises inserting the reference probe into the sample and leaving the reference probe in contact with the sample for a time period of seconds, minutes, hours, days, weeks, months, or years.

Some embodiments relate to kits, e.g., a kit comprising a double junction reference electrode comprising: a substrate; and a housing attached to the substrate, the housing comprising a first chamber; an inner wall comprising a first frit; and a second chamber comprising a hollow reference probe structure comprising a second frit; and a positive or negative control. In some embodiments, kits comprise a double junction reference electrode comprising a substrate; and a housing attached to the substrate, the housing comprising a first chamber; an inner wall comprising a first frit; and a second chamber comprising a hollow reference probe structure comprising a second frit; and a vessel for testing a sample. In some embodiments, kits comprise a double junction reference electrode comprising a substrate; and a housing attached to the substrate, the housing comprising a first chamber; an inner wall comprising a first frit; and a second chamber comprising a hollow reference probe structure comprising a second frit; and a consumable working electrode.

Some portions of this description describe the embodiments of the technology in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times to refer to these arrangements of operations as modules, without loss of generality. The described operations and their associated modules may be embodied in software, firmware, hardware, or any combinations thereof.

Certain steps, operations, or processes described herein may be performed or implemented with one or more hardware or software modules, alone or in combination with other devices. In some embodiments, a software module is implemented with a computer program product comprising a computer-readable medium containing computer program code, which can be executed by a computer processor for performing any or all steps, operations, or processes described.

In some embodiments, systems comprise a computer and/or data storage provided virtually (e.g., as a cloud computing resource). In particular embodiments, the technology comprises use of cloud computing to provide a virtual computer system that comprises the components and/or performs the functions of a computer as described herein. Thus, in some embodiments, cloud computing provides infrastructure, applications, and software as described herein through a network and/or over the internet. In some embodiments, computing resources (e.g., data analysis, calculation, data storage, application programs, file storage, etc.) are remotely provided over a network (e.g., the internet; and/or a cellular network).

Embodiments of the technology may also relate to an apparatus for performing the operations herein. This apparatus may be specially constructed for the required purposes and/or it may comprise a general-purpose computing device selectively activated or reconfigured by a computer program stored in the computer. Such a computer program may be stored in a non-transitory, tangible computer readable storage medium or any type of media suitable for storing electronic instructions, which may be coupled to a computer system bus. Furthermore, any computing systems referred to in the specification may include a single processor or may be architectures employing multiple processor designs for increased computing capability.

Additional embodiments will be apparent to persons skilled in the relevant art based on the teachings contained herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features, aspects, and advantages of the present technology will become better understood with regard to the following drawings.

FIG. 1A is a schematic drawing of an embodiment of a double junction reference electrode.

FIG. 1B is a drawing of an embodiment of a double junction reference electrode.

FIG. 1C is a drawing of an embodiment of a double junction reference electrode showing electrical connections.

FIG. 2A is a schematic drawing of an embodiment of a double junction reference electrode comprising multiple reference probes associated with the second chamber.

FIG. 2B is a schematic drawing of the double junction reference electrode comprising multiple reference probes associated with the second chamber as shown in FIG. 2A with the multiple probes contacting multiple samples.

FIG. 3 is a schematic drawing of a plurality of individual double junction reference electrodes provided on a unitary substrate.

FIG. 4 is a drawing of an embodiment of a handheld integrated device comprising an embodiment of a double junction reference electrode design comprising multiple reference probes.

FIG. 5 is a plot relating the nitrogen concentrations measured by an embodiment of the double junction reference electrode to the actual nitrogen concentrations of a series of nitrate standards.

FIG. 6 is a series of plots relating the nitrogen concentrations measured by an embodiment of the double junction reference electrode to the actual nitrogen concentrations of a series of nitrate standards at room temperature and at 50° C.

FIG. 7 is a plot relating a number of in vivo nitrogen concentrations measured by an embodiment of the double junction reference electrode relative to the in vivo nitrogen concentrations measured by a conventional spectrophotometric method.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

Provided herein is technology relating to electrochemical detection of analytes and particularly, but not exclusively, to a double junction reference electrode, methods of using a double junction reference electrode, handheld apparatuses comprising a double junction reference electrode, and systems comprising a double junction reference electrode.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless defined otherwise, all technical and scientific terms used herein have the same meaning as is commonly understood by one of ordinary skill in the art to which the various embodiments described herein belongs. When definitions of terms in incorporated references appear to differ from the definitions provided in the present teachings, the definition provided in the present teachings shall control. The section headings used herein are for organizational purposes only and are not to be construed as limiting the described subject matter in any way.

### Definitions

To facilitate an understanding of the present technology, a number of terms and phrases are defined below. Additional definitions are set forth throughout the detailed description.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a”, “an”, and “the” include plural references. The meaning of “in” includes “in” and “on.”

As used herein, the terms “about”, “approximately”, “substantially”, and “significantly” are understood by persons of ordinary skill in the art and will vary to some extent on the context in which they are used. If there are uses of these terms that are not clear to persons of ordinary skill in the art given the context in which they are used, “about” and “approximately” mean plus or minus less than or equal to 10% of the particular term and “substantially” and “significantly” mean plus or minus greater than 10% of the particular term.

As used herein, disclosure of ranges includes disclosure of all values and further divided ranges within the entire range, including endpoints and sub-ranges given for the ranges. As used herein, the disclosure of numeric ranges includes the endpoints and each intervening number therebetween with the same degree of precision. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are explicitly contemplated.

As used herein, the suffix “-free” refers to an embodiment of the technology that omits the feature of the base root of the word to which “-free” is appended. That is, the term “X-free” as used herein means “without X”, where X is a feature of the technology omitted in the “X-free” technology. For example, a “calcium-free” composition does not comprise calcium, a “mixing-free” method does not comprise a mixing step, etc.

Although the terms “first”, “second”, “third”, etc. may be used herein to describe various steps, elements, compositions, components, regions, layers, and/or sections, these steps, elements, compositions, components, regions, layers, and/or sections should not be limited by these terms, unless otherwise indicated. These terms are used to distinguish one step, element, composition, component, region, layer, and/or section from another step, element, composition, component, region, layer, and/or section. Terms such as “first”, “second”, and other numerical terms when used herein do not imply a sequence or order unless clearly indicated by the context. Thus, a first step, element, composition, component, region, layer, or section discussed herein could be termed a second step, element, composition, component, region, layer, or section without departing from technology.

As used herein, the word “presence” or “absence” (or, alternatively, “present” or “absent”) is used in a relative sense to describe the amount or level of a particular entity (e.g., an analyte). For example, when an analyte is said to be “present” in a test sample, it means the level or amount of this analyte is above a pre-determined threshold; conversely, when an analyte is said to be “absent” in a test sample, it means the level or amount of this analyte is below a pre-determined threshold. The pre-determined threshold may be the threshold for detectability associated with the particular test used to detect the analyte or any other threshold. When an analyte is “detected” in a sample it is “present” in the sample; when an analyte is “not detected” it is “absent” from the sample. Further, a sample in which an analyte is “detected” or in which the analyte is “present” is a sample that is “positive” for the analyte. A sample in which an analyte is “not detected” or in which the analyte is “absent” is a sample that is “negative” for the analyte. The term “presence” or “absence” (or, alternatively, “present” or “absent”) may also be used in a relative sense to describe the amount or level of a particular entity (e.g., component, action, element). For example, when an entity is said to be “present”, it means the level or amount of this entity is above a pre-determined threshold; conversely, when an entity is said to be “absent”, it means the level or amount of this entity is below a pre-determined threshold. The pre-determined threshold may be the threshold for detectability associated with the particular test used to detect the entity or any other threshold. When an entity is “detected” it is “present”; when an entity is “not detected” it is “absent”.

As used herein, an “increase” or a “decrease” refers to a detectable (e.g., measured) positive or negative change, respectively, in the value of a variable relative to a previously measured value of the variable, relative to a pre-established value, and/or relative to a value of a standard control. An increase is a positive change preferably at least 10%, more preferably 50%, still more preferably 2-fold, even more preferably at least 5-fold, and most preferably at least 10-fold relative to the previously measured value of the variable, the pre-established value, and/or the value of a standard control. Similarly, a decrease is a negative change preferably at least 10%, more preferably 50%, still more preferably at least 80%, and most preferably at least 90% of the previously measured value of the variable, the pre-established value, and/or the value of a standard control. Other terms indicating quantitative changes or differences, such as “more” or “less,” are used herein in the same fashion as described above.

As used herein, an “analyte” refers to a substance or component of a sample for which the presence, absence, amount, and/or concentration is sought to be determined, detected, and/or measured qualitatively and/or quantitatively. Non-limiting examples of analytes include cations and anions, e.g., H⁺, Li⁺, Na⁺, K⁺, Mg²⁺, Ca²⁺, Cu²⁺, Ag⁺, Zn²⁺, Cd²⁺, Hg²⁺, Pb²⁺, NH₄⁺, carbonate, bicarbonate, nitrate, nitrite, sulfide, chloride, and iodide.

As used herein, a “result” or “test result” refers to an indication (e.g., a value) qualitatively and/or quantitatively describing the presence, absence, amount, and/or concentration of an analyte.

As used herein, a “system” refers to a plurality of real and/or abstract components operating together for a common purpose. In some embodiments, a “system” is an integrated assemblage of hardware and/or software components. In some embodiments, each component of the system interacts with one or more other components and/or is related to one or more other components. In some embodiments, a system refers to a combination of components and software for controlling and directing methods. For example, a “system” or “subsystem” may comprise one or more of, or any combination of, the following: mechanical devices, hardware, components of hardware, circuits, circuitry, logic design, logical components, software, software modules, components of software or software modules, software procedures, software instructions, software routines, software objects, software functions, software classes, software programs, files containing software, etc., to perform a function of the system or subsystem. Thus, the methods and apparatus of the embodiments, or certain aspects or portions thereof, may take the form of program code (e.g., instructions) embodied in tangible media, such as floppy diskettes, CD-ROMs, hard drives, flash memory, or any other machine-readable storage medium wherein, when the program code is loaded into and executed by a machine, such as a computer, the machine becomes an apparatus for practicing the embodiments. In the case of program code execution on programmable computers, the computing device generally includes a processor, a storage medium readable by the processor (e.g., volatile and non-volatile memory and/or storage elements), at least one input device, and at least one output device. One or more programs may implement or utilize the processes described in connection with the embodiments, e.g., through the use of an application programming interface (API), reusable controls, or the like. Such programs are preferably implemented in a high-level procedural or object-oriented programming language to communicate with a computer system. However, the program(s) can be implemented in assembly or machine language, if desired. In any case, the language may be a compiled or interpreted language, and combined with hardware implementations.

As used herein, the term “network” generally refers to any suitable electronic network including, but not limited to, a wide area network (“WAN”) (e.g., a TCP/IP based network), a local area network (“LAN”), a neighborhood area network (“NAN”), a home area network (“HAN”), or personal area network (“PAN”) employing any of a variety of communications protocols, such as Wi-Fi, Bluetooth, ZigBee, etc. In some embodiments, the network is a cellular network, such as, for example, a Global System for Mobile Communications (“GSM”) network, a General Packet Radio Service (“GPRS”) network, an Evolution-Data Optimized (“EV-DO”) network, an Enhanced Data Rates for GSM Evolution (“EDGE”) network, a 3GSM network, a 4GSM network, a 5G New Radio, a Digital Enhanced Cordless Telecommunications (“DECT”) network, a digital AMPS (“IS-136/TDMA”) network, or an Integrated Digital Enhanced Network (“MEN”) network, etc.

As used herein, the term “computer” generally includes a plurality of electrical and electronic components that provide power, operational control, and protection to the components and modules within the system. For example, a computer can include, among other things, a processing unit (e.g., a microprocessor, a microcontroller, or other suitable programmable device), a memory, input units, and output units. The processing unit can include, among other things, a control unit, an arithmetic logic unit (“ALC”), and a plurality of registers, and can be implemented using a known computer architecture (e.g., a modified Harvard architecture, a von Neumann architecture, etc.). A “microprocessor” or “processor” refers to one or more microprocessors that can be configured to communicate in a stand-alone and/or a distributed environment, and can be configured to communicate via wired or wireless communications with other processors, where such one or more processor can be configured to operate on one or more processor-controlled devices that can be similar or different devices.

As used herein, the term “memory” generally refers to any memory storage of the computer and is a non-transitory computer readable medium. The memory can include, for example, a program storage area and the data storage area. The program storage area and the data storage area can include combinations of different types of memory, such as a ROM, a RAM (e.g., DRAM, SDRAM, etc.), EEPROM, flash memory, a hard disk, a SD card, or other suitable magnetic, optical, physical, or electronic memory devices. The processing unit can be connected to the memory and execute software instructions that are capable of being stored in a RAM of the memory (e.g., during execution), a ROM of the memory (e.g., on a generally permanent bases), or another non-transitory computer readable medium such as another memory or a disc. “Memory” can include one or more processor-readable and accessible memory elements and/or components that can be internal to the processor-controlled device, external to the processor-controlled device, and can be accessed via a wired or wireless network. Software included in the implementation of the methods disclosed herein can be stored in the memory. The software includes, for example, firmware, one or more applications, program data, filters, rules, one or more program modules, and other executable instructions. For example, the computer can be configured to retrieve from the memory and execute, among other things, instructions related to the processes and methods described herein.

As used herein, the term “structured to [verb]” means that the identified element or assembly has a structure that is shaped, sized, disposed, coupled, and/or configured to perform the identified verb. For example, a member that is “structured to move” is movably coupled to another element and includes elements that cause the member to move or the member is otherwise configured to move in response to other elements or assemblies. As such, as used herein, “structured to [verb]” recites structure and not function. Further, as used herein, “structured to [verb]” means that the identified element or assembly is intended to, and is designed to, perform the identified verb.

As used herein, the term “associated” means that the elements are part of the same assembly and/or operate together or act upon/with each other in some manner. For example, an automobile has four tires and four hub caps. While all the elements are coupled as part of the automobile, it is understood that each hubcap is “associated” with a specific tire.

As used herein, the term “coupled” refers to two or more components that are secured, by any suitable means, together. Accordingly, in some embodiments, the statement that two or more parts or components are “coupled” shall mean that the parts are joined or operate together either directly or indirectly, e.g., through one or more intermediate parts or components. As used herein, “directly coupled” means that two elements are directly in contact with each other. As used herein, “fixedly coupled” or “fixed” means that two components are coupled so as to move as one while maintaining a constant orientation relative to each other. Accordingly, when two elements are coupled, all portions of those elements are coupled. A description, however, of a specific portion of a first element being coupled to a second element, e.g., an axle first end being coupled to a first wheel, means that the specific portion of the first element is disposed closer to the second element than the other portions thereof. Further, an object resting on another object held in place only by gravity is not “coupled” to the lower object unless the upper object is otherwise maintained substantially in place. That is, for example, a book on a table is not coupled thereto, but a book glued to a table is coupled thereto.

As used herein, the term “removably coupled” or “temporarily coupled” means that one component is coupled with another component in an essentially temporary manner. That is, the two components are coupled in such a way that the joining or separation of the components is easy and does not damage the components. Accordingly, “removably coupled” components may be readily uncoupled and recoupled without damage to the components.

As used herein, the term “operatively coupled” means that a number of elements or assemblies, each of which is movable between a first position and a second position, or a first configuration and a second configuration, are coupled so that as the first element moves from one position/configuration to the other, the second element moves between positions/configurations as well. It is noted that a first element may be “operatively coupled” to another without the opposite being true.

As used herein, the term “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are to fit “snugly” together. In that situation, the difference between the size of the components is even smaller whereby the amount of friction increases. If the element defining the opening and/or the component inserted into the opening are made from a deformable or compressible material, the opening may even be slightly smaller than the component being inserted into the opening. With regard to surfaces, shapes, and lines, two, or more, “corresponding” surfaces, shapes, or lines have generally the same size, shape, and contours.

As used herein, the term “number” shall mean one or an integer greater than one (e.g., a plurality).

As used herein, the term “planar element” or “planar component” is a generally thin element including opposed, wide, generally flat surfaces as well as a thinner edge surface extending between the wide flat surfaces. The edge surface may include generally flat portions, e.g. as on a rectangular planar member, or be curved, as on a disk, or have any other shape.

As used herein, and when used in reference to communicating data or a signal, “in electronic communication” includes both hardline and wireless forms of communication.

As used herein, “in electric communication” or “in electrical communication” means that a current passes, or can pass, between the identified elements. Being “in electric communication” is further dependent upon an element's position or configuration. For example, in a circuit breaker or a switch, a movable contact is “in electric communication” with the fixed contact when the contacts are in a closed position. The same movable contact is not “in electric communication” with the fixed contact when the contacts are in the open position.

As used herein, the word “unitary” means a component is created as a single piece or unit. That is, a component that includes pieces that are created separately and then coupled together as a unit is not a “unitary” component or body.

As used herein, the term “providing”, with respect to an article or apparatus, refers broadly to making the article available or accessible for future actions to be performed with or on the article, and does not connote that any particular person or entity providing the article has manufactured, produced, or supplied the article or that the person or entity providing the article has ownership or control of the article.

As used herein, the term “plant part” refers to a plant structure or a plant tissue, for example, pollen, an ovule, a tissue, a pod, a seed, a leaf, or a cell.

As used herein, the term “plant tissue” refers to differentiated and undifferentiated tissues of plants including but not limited to protoplasts, leaves, stems, roots, root tips, anthers, pistils, seed, grain, embryo, pollen, ovules, cotyledon, hypocotyl, pod, flower, shoot, tissue, petiole, cells, meristematic cells, tumors, and plant cells in culture (e.g., single cells, protoplasts, embryos, callus, etc.). Plant tissue may be in planta, in organ culture, tissue culture, or cell culture.

As used herein, the term “sample” is used in its broadest sense. In one sense it can refer to a plant cell or tissue, such as a leaf. In another sense, it is meant to include a specimen or culture obtained from any source, as well as biological and environmental samples. Biological samples may be obtained from plants or animals and encompass fluids, solids, tissues, and gases. Environmental samples include environmental material such as surface matter, soil, water, salt, and industrial samples. These examples are not to be construed as limiting the sample types applicable to the present technology.

### Description

Provided herein is technology relating to electrochemical detection of analytes and particularly, but not exclusively, to a double junction reference electrode, methods of using a double junction reference electrode, handheld apparatuses comprising a double junction reference electrode, and systems comprising a double junction reference electrode.

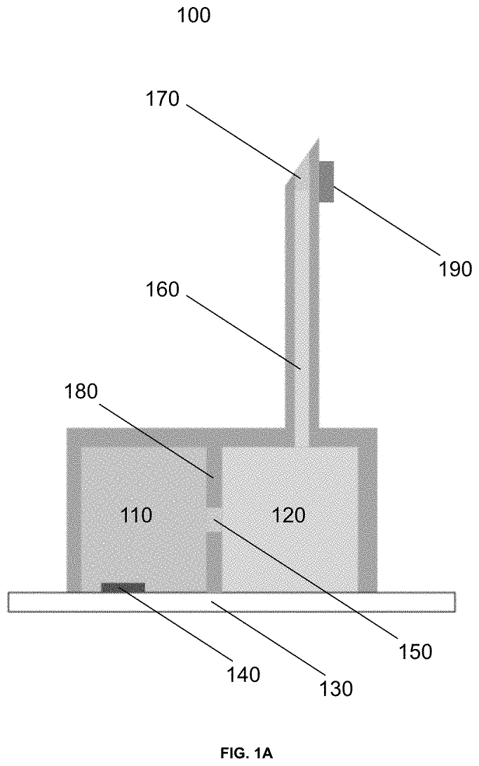

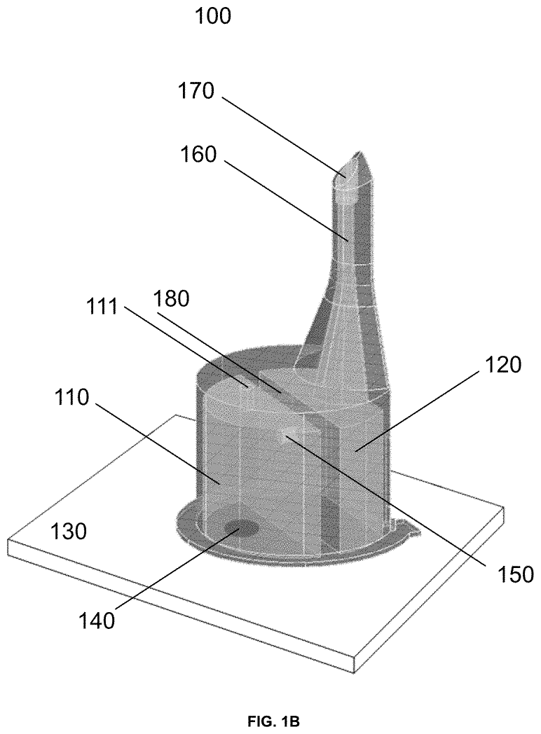

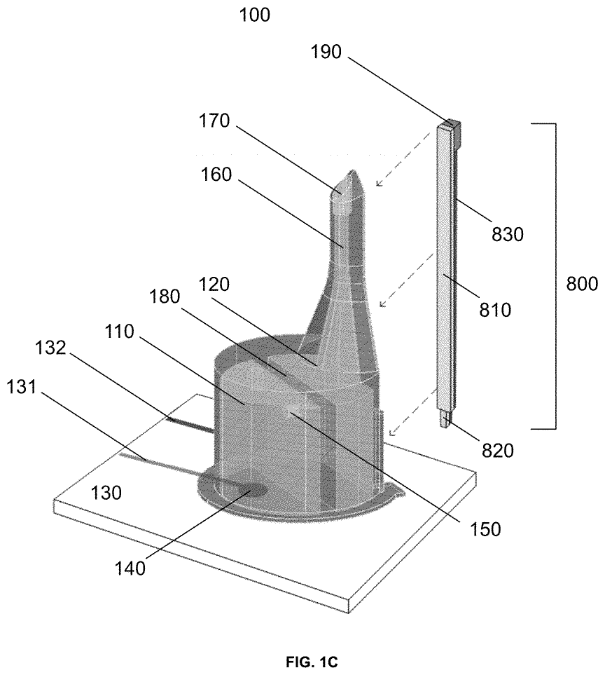

In some embodiments, e.g., as shown in FIG. 1A and FIG. 1B, provided herein is a double junction reference electrode 100. The double junction reference electrode 100 comprises a first chamber 110, a second chamber 120, and a substrate 130. The first chamber 110 is deposited on the surface of the substrate 130, and the second chamber 120 is deposited on the surface of the substrate 130. Further, the first chamber 110 and second chamber 120 are deposited side by side on the surface of the substrate 130.

The first chamber 110 and the second chamber 120 comprise outer walls. An inner wall 180 (comprising a first frit 150) separates the first chamber 110 from the second chamber 120. The first frit 150 may be placed anywhere within the inner wall 180 between the first chamber 110 and the second chamber 120.

The outer walls of the first chamber 110, the inner wall 180, and the substrate 130 define a volume of the first chamber. The outer walls of the second chamber 120, the inner wall 180, and the substrate 130 define a volume of the second chamber 120. In some embodiments, an outer wall of the first chamber 110 comprises a loading hole 111 for providing compositions (e.g., an electrolyte solution) into the first chamber 110. The inner wall 180, the outer walls, and the substrate 130 comprise one or more impermeable and unreactive material(s) that do not allow passage and/or allow minimal passage of materials (e.g., gases, liquids, ions, or nonionic species) across (e.g., through) the inner wall 180, the outer walls, and the substrate 130 and that are minimally reactive and/or unreactive with materials (e.g., in a sample, a first electrolyte, and/or a second electrolyte as discussed below) they contact.

A planar electrode 140 is formed on the substrate 130 within the first chamber 110. The first chamber 110 comprises a first electrolyte solution (e.g., a gel electrolyte) and the second chamber 120 (comprises a second electrolyte solution (e.g., a gel electrolyte). Thus, the planar electrode 140 is in electrical communication with the first electrolyte. The inner wall 180 comprises a first frit 150 that separates the first chamber 110 and the second chamber 120. The first frit 150 minimizes and/or eliminates (e.g., substantially and/or effectively eliminates) mixing of the first electrolyte solution with the second electrolyte solution while allowing ionic conductivity between the first electrolyte solution and the second electrolyte solution. Thus, the first electrolyte solution and the second electrolyte solution are in electrical communication. The first frit 150 may be placed anywhere within the inner wall 180 provided that it minimizes and/or eliminates (e.g., substantially and/or effectively eliminates) mixing of the first electrolyte solution with the second electrolyte solution while allowing ionic conductivity between the first electrolyte solution and the second electrolyte solution.

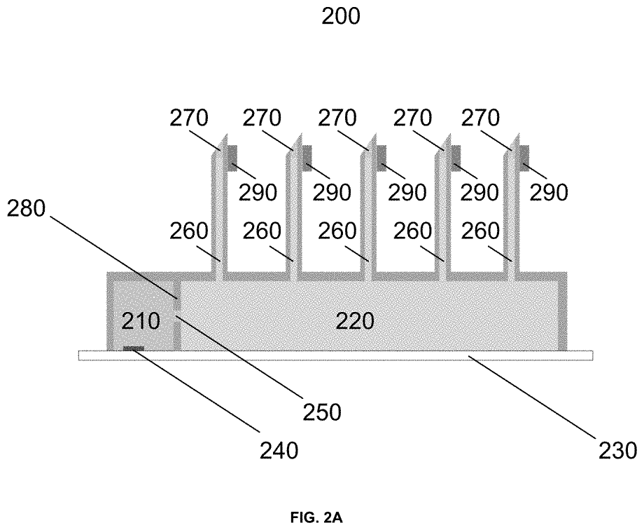

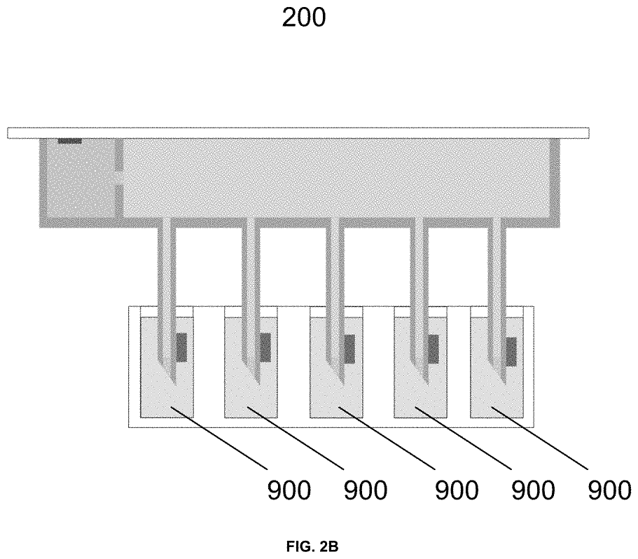

The second chamber 120 comprises a reference probe 160. In some embodiments, the reference probe 160 is a hollow, thin tube or needle. The reference probe 160 has a proximal end connected with and in liquid communication with the second chamber 120, and the reference probe 160 has a distal end. Thus, the reference probe 160 comprises the second electrolyte solution. That is, the second chamber 120 and the reference probe 160 comprise a volume of a second electrolyte (e.g., a gel electrolyte). The distal end of the reference probe 160 comprises a second frit 170. The second frit 170 separates the second chamber 120 and the sample. The second frit 170 minimizes and/or eliminates (e.g., substantially and/or effectively eliminates) mixing of the second electrolyte solution with the sample while allowing ionic conductivity between the second electrolyte solution and the sample. In some embodiments, the distal end of the reference probe 160 comprises a tapered end (e.g., provided by a tip portion) that facilitates insertion of the reference probe 160 into a sample. The reference probe 160 comprises a sensing element 190. In some embodiments, the reference probe 160 comprises a sensing element 190 at the distal end of the reference probe 160. In some embodiments, the second chamber 120 comprises a plurality of reference probes 160 as described below. See, e.g., FIG. 2A. In some embodiments, the sensing element 190 comprises an ion-selective electrode.

In some embodiments, the double junction reference electrode comprises a planar electrode that is a silver/silver chloride (Ag/AgCl) planar electrode. In some embodiments, the double junction reference electrode comprises a substrate that is a printed circuit board (PCB). In some embodiments, the PCB comprises one or more circuits and/or electronic components in electrical communication with the Ag/AgCl planar electrode and/or sensing element.

For example, e.g., as shown in FIG. 1C, embodiments of the double junction reference electrode comprise a first electrical wire 131 of the substrate 130 in electrical communication with the planar electrode 140 (e.g., a silver-silver chloride (Ag/AgCl) electrode) formed on the substrate 130. The reference potential from the double junction reference electrode is acquired from this electrical wire. Accordingly, methods comprise obtaining a reference potential measurement from the electrical wire in electrical communication with the planar electrode. Further, e.g., as shown in FIG. 1A and 1C, the double junction reference electrode comprises a sensing element 190 (e.g., comprising an ion-selective electrode), e.g., at the distal end of the reference probe 160. In some embodiments, the double junction reference electrode comprises a sensing component 800 attached to the reference probe 160. See, e.g., FIG. 1C. In some embodiments, the sensing component 800 comprises a base 810 and the sensing element 190 (e.g., comprising an ion-selective electrode). In some embodiments, the base 810 is in the shape of a thin strip. In some embodiments, the base 810 is a printed circuit board (PCB). In some embodiments, the base 810 comprises plastic, glass, or silicon. This base 810 is placed against the reference probe, e.g., as shown in FIG. 1C. In some embodiments, the sensing component 800 comprise an electrical contact pin 820 (e.g., in some embodiments, the base 810 comprises an electrical contact pin 820) that is inserted into a connector of the substrate 130 (e.g., a PCB substrate 130). In some embodiments, the sensing component 800 comprises an electrical wire 830 providing electrical communication between the sensing element 190 and the electrical contact pin 820. Thus, in some embodiments, the sensing component 800 is in electrical communication with the substrate 130, e.g., the sensing element 190 is in electrical communication with the PCB substrate 130 through the wire 830 and the contact pin 820. A signal from the sensing element 190 is obtained from a second electrical wire 132 of the substrate 130 (e.g., a second electrical wire 132 of the PCB substrate 130 that is in electrical communication with the sensing element 190). Embodiments provide that the double junction reference electrode finds use in potentiometric methods and, accordingly, embodiments provide that the double junction reference electrode does not require a source of power or voltage (e.g., embodiments provide a power-free double junction reference electrode). However, in some embodiments, the double junction reference electrode may comprise a power (e.g., voltage) source and/or may be in electrical communication with a power (e.g., voltage) source. In some embodiments, the double junction reference electrode communicates with a data logger (e.g., for reading, processing, and transmitting signals) and the data logger is in electrical communication with a power (e.g., voltage) source.

### Methods of Manufacturing

The double junction reference electrode described herein may be manufactured using a number of manufacturing processes and a number of materials. For example, in some embodiments, the technology provides a method of manufacturing a double junction reference electrode comprising forming a housing comprising a first chamber; a second chamber comprising a hollow reference probe structure; and an inner wall separating the first chamber from the second chamber and comprising a hole structured to accept a frit. In some embodiments, the first chamber of the housing comprises a loading hole, e.g., a loading hole provided in an outer wall of the first chamber (see below).

In some embodiments, the housing is produced using three-dimensional printing. Further, in some embodiments, the housing is produced using injection molding or computer numerical control (CNC) machining In some embodiments, the housing is produced by hot embossing, compression molding, or soft lithography.

Moreover, the technology is not limited in the material used to produce the housing provided that the material is appropriate for the method of manufacturing used to produce the housing. For example, in some embodiments, the housing comprises a plastic (e.g., a thermoplastic) material (e.g., polyurethane, polycarbonate, acrylic, etc.) In some embodiments, the housing comprises a metal material (e.g., aluminum, stainless steel, titanium, etc.)

In some embodiments, e.g., as shown in FIG. 1B, the housing has a cylindrical shape. In some embodiments, e.g., as shown in FIG. 1B, the first chamber has a half-cylindrical shape. In some embodiments, the first chamber has a radius of approximately 9 mm (e.g., 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0 mm) and a height of approximately 8 mm (e.g., 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0 mm). In some embodiments, e.g., as shown in FIG. 1B, the second chamber has a half-cylindrical shape. In some embodiments, the second chamber has a radius of approximately 9 mm (e.g., 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0 mm) and a height of approximately 8mm (e.g., 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0 mm). Accordingly, embodiments provide that the housing has a volume of approximately 1500 to 3500 mm³ (e.g., 1500, 1550, 1600, 1650, 1700, 1750, 1800, 1850, 1900, 1950, 2000, 2050, 2100, 2150, 2200, 2250, 2300, 2350, 2400, 2450, 2500, 2550, 2600, 2650, 2700, 2750, 2800, 2850, 2900, 2950, 3000, 3050, 3100, 3150, 3200, 3250, 3300, 3350, 3400, 3450, or 3500 mm³); embodiments further provide that the first chamber has a volume of approximately 700 to 1800 mm³ (e.g., 700, 750, 800, 850, 900, 950, 1000, 1050, 1100, 1150, 1200, 1250, 1300, 1350, 1400, 1450, 1500, 1550, 1600, 1650, 1700, 1750, or 1800 mm3); and embodiments further provide that the second chamber has a volume of approximately 700 to 1800 mm³ (e.g., 700, 750, 800, 850, 900, 950, 1000, 1050, 1100, 1150, 1200, 1250, 1300, 1350, 1400, 1450, 1500, 1550, 1600, 1650, 1700, 1750, or 1800 mm3).

The shape of the housing is not limited to a cylindrical shape and embodiments provide that the shape of the housing may be a rectangular prism, a cube, or other polygonal prism (e.g., a three⁻dimensional shape having a top and a bottom that are polygons having 4, 5, 6, 7, 8, 9, 10, 11, 12, 13, 14, 15, 16, 17, 18, 19, or 20 or more sides).

In some embodiments, the reference probe is in the shape of a cylinder or half⁻ cylinder having a radius of approximately 3 mm (e.g., 2.5, 2.6, 2.7, 2.8, 2.9, 3.0, 3.1, 3.2, 3.3, 3.4, or 3.5 mm) and a height of approximately 10 to 30 mm (e.g., 9, 10, 11, 12, 13, 14, 15, 16, 17, 18, 19, 20, 21, 22, 23, 24, 25, 26, 27, 28, 29, 30, 31, 32, 33, 34, or 35 mm) In some embodiments, e.g., as shown in FIG. 1B, the reference probe comprises a base portion having a shape of a cone or half-cone attached to the second chamber, a central portion having a shape of a cylinder or half cylinder attached to the base portion, and a tip portion having a shape of a cone of half-cone attached to the central portion. In some embodiments, the base portion is a cone or half-cone comprising a base having a radius of 4 mm (e.g., 3.5, 3.6, 3.7, 3.8, 3.9, 4.0, 4.1, 4.2, 4.3, 4.4, or 4.5 mm) and a height of 10 mm (e.g., 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, or 11.0 mm); the central portion is a cylinder or half-cylinder having a radius of 3 mm (e.g., 2.5, 2.6, 2.7, 2.8, 2.9, 3.0, 3.1, 3.2, 3.3, 3.4, or 3.5 mm) and a height of 10 mm (e.g., 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, or 11 0 mm); and the tip portion is a cone or half-cone comprising a base having a radius of 3 mm (e.g., 2.5, 2.6, 2.7, 2.8, 2.9, 3.0, 3.1, 3.2, 3.3, 3.4, or 3.5 mm) and a height of 3 mm (e.g., 2.5, 2.6, 2.7, 2.8, 2.9, 3.0, 3.1, 3.2, 3.3, 3.4, or 3.5 mm).

In some embodiments, methods of manufacturing a double junction reference electrode provided herein further comprise inserting a frit into the hole of the inner wall of the housing separating the first chamber of the housing from the second chamber of the housing. The technology is not limited in the materials used for the frit. For example, in some embodiments, the frit comprises a plastic (e.g., a thermoplastic) (e.g., polyethylene) or a metal. The frit comprises pores having a mean pore size of approximately 0.5 μm. In some embodiments, the frit comprises pores having a mean pore size of 0.1 μm to 50 μm (e.g., 0.1, 0.2, 0.5, 1.0, 2.0, 5.0. 10.0, 20.0, or 50.0 p.m).

In some embodiments, methods of manufacturing a double junction reference electrode provided herein further comprise providing a substrate comprising a planar electrode on the substrate surface. In some embodiments, the electrode is a silver-silver chloride electrode (Ag/AgCl electrode). In some embodiments, the substrate comprises a first surface comprising a printed circuit board and a second surface comprising an integrated planar electrode. In some embodiments, the substrate comprises a first wire in electrical connection with the planar electrode. In some embodiments, the first wire is in electrical communication with an external analog-to-digital converter, datalogger, computer, communications component, etc.

Next, embodiments of methods of manufacturing a double junction reference electrode provided herein further comprise attaching the housing to the substrate surface comprising the planar electrode such that the planar electrode is positioned within the first chamber of the housing. In some embodiments, attaching the housing to the substrate comprises adhering the housing (e.g., using an adhesive (e.g., a glue)) to the substrate surface comprising the planar electrode such that the planar electrode is positioned within the first chamber of the housing. Thus, in some embodiments, methods of manufacturing a double junction reference electrode comprise gluing the housing to the to the substrate surface comprising the planar electrode such that the planar electrode is positioned within the first chamber of the housing. Further, in some embodiments, the adhesive is an impermeable adhesive (e.g., an impermeable glue) that provides a seal between the first chamber and the substrate, provides a seal between the second chamber and the substrate, and that seals (e.g., separates) the first chamber and second chamber from each other.

In some embodiments, methods of manufacturing a double junction reference electrode provided herein further comprise providing an electrolyte solution (e.g., a gel electrolyte or a liquid-state electrolyte solution) into the first chamber (e.g., through a loading hole 111 provided in an outer wall of the first chamber, e.g., as shown in FIG. 1B). In some embodiments, a gel electrolyte is prepared by mixing a liquified gelling agent and a salt to provide a liquified gel electrolyte. Then, the liquified gel electrolyte is loaded into the first chamber (e.g., through a loading hole provided in an outer wall of the first chamber) and the liquified gel electrolyte is cooled (e.g., at room temperature) to provide a gelatinized gel electrolyte in the first chamber. In some embodiments, a potassium chloride/silver chloride liquified gel electrolyte is prepared by mixing liquified agar (e.g., agar powder in water) and 3 M potassium chloride saturated with silver chloride at a temperature greater than 98° C. Then, the potassium chloride/silver chloride liquified agar gel electrolyte is loaded into the first chamber (e.g., through a loading hole of the first chamber) and the potassium chloride/silver chloride liquified agar gel electrolyte is cooled (e.g., at room temperature) to provide a potassium chloride/silver chloride gelatinized gel electrolyte in the first chamber. In some embodiments, a liquid-state electrolyte (e.g., comprising potassium chloride and saturated with silver chloride) is loaded into the first chamber (e.g., through a loading hole of the first chamber).

In some embodiments, methods of manufacturing a double junction reference electrode provided herein further comprise sealing the loading hole (e.g., loading hole 111) of the first chamber after the electrolyte is loaded into the first chamber. In some embodiments, sealing the loading hole comprises providing an epoxy composition into the loading hole and allowing the epoxy composition to harden and seal the loading hole of the first chamber.

In some embodiments, methods of manufacturing a double junction reference electrode provided herein further comprise providing an electrolyte solution (e.g., a gel or liquid-state electrolyte solution) into the second chamber (e.g., through an opening of the tip portion of the reference probe). In some embodiments, the gel electrolyte is prepared by mixing a liquified gelling agent and a salt to provide a liquified gel electrolyte. Then, the liquified gel electrolyte is loaded into the second chamber (e.g., through an opening of the tip portion of the reference probe) and the liquified gel electrolyte is cooled (e.g., at room temperature) to provide a gelatinized gel electrolyte in the second chamber. In some embodiments, a lithium acetate liquified gel electrolyte is prepared by mixing liquified agar (e.g., agar powder in water) and 0.1 M lithium acetate at a temperature greater than 98° C. Then, the lithium acetate liquified agar gel electrolyte is loaded into the second chamber (e.g., through an opening of a tip portion of the reference probe) and the lithium acetate liquified agar gel electrolyte is cooled (e.g., at room temperature) to provide a gelatinized lithium acetate gel electrolyte in the second chamber. In some embodiments, a liquid-state electrolyte (e.g., comprising lithium acetate) is loaded into the second chamber (e.g., through an opening of the tip portion of the reference probe).

In some embodiments, methods of manufacturing a double junction reference electrode provided herein further comprise inserting a frit into the opening of the tip portion of the reference probe. The technology is not limited in the materials used for the frit inserted into the opening of the tip of the reference probe. For example, in some embodiments, the frit inserted into the opening of the tip of the reference probe comprises a plastic (e.g., a thermoplastic) (e.g., polyethylene) or a metal. The frit inserted into the opening of the tip of the reference probe comprises pores having a mean pore size of approximately 0.5 μm. In some embodiments, the frit comprises pores having a mean pore size of 0.1 μm to 50 μm (e.g., 0.1, 0.2, 0.5, 1.0, 2.0, 5.0. 10.0, 20.0, or 50.0 μm).

In some embodiments, methods of manufacturing a double junction reference electrode provided herein further comprise attaching a sensing element to the reference probe. The technology is not limited in the type of sensing element that may be attached to the reference probe. For example, in some embodiments, the sensing element is an amperometric electrochemical sensor, a voltammetric electrochemical sensor, or an electrochemical impedance spectroscopy-based sensor. As used herein, the term “sensing element” (e.g., an “electrochemical sensor”) refers to a component or device configured to detect the presence of and/or measure the concentration of an analyte using electrochemical oxidation and reduction reactions. These reactions are transduced to an electrical signal that can be correlated to an amount or concentration of analyte. In some embodiments, methods of manufacturing a double junction reference electrode provided herein comprise attaching a sensing component (e.g., comprising a base, a sensing element, a wire, and an electrical contact pin) to the reference probe. In some embodiments, methods comprise inserting an electrical contact pin of the sensing component into a connector of the substrate. In some embodiments, the substrate comprises a second wire in electrical connection with the sensing element. In some embodiments, the second wire is in electrical communication with an external analog-to-digital converter, datalogger, computer, communications component, etc.

In some embodiments, a plurality of double junction reference probes is manufactured by producing a plurality of housings as described above, attaching each of the plurality of housings to a substrate, and producing the plurality of double junction reference probes by partitioning the substrate (e.g., by cutting the substrate between the individual double junction reference probes) into individual double junction reference probes. The steps of the manufacturing process for loading the electrolytes, placing the frits, sealing the loading holes, and/or attaching the sensing elements to the reference probes may be performed prior to or after partitioning the substrate (e.g., by cutting the substrate between the individual double junction reference probes) into individual double junction reference probes. In some embodiments, the technology relates to fabricating a plurality (e.g., at least 20, 25, 30, 35, 40, 45, 50, 55, 60, 65, 70, 75, 80, 85, 90, 95, 100, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, or more) of double junction reference probes on a unitary substrate and then partitioning the substrate to provide a plurality (e.g., at least 20, 25, 30, 35, 40, 45, 50, 55, 60, 65, 70, 75, 80, 85, 90, 95, 100, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, or more) of individual double junction reference probes.

### Multiple Reference Probe Devices

In some embodiments, the technology provides multiple reference probe designs. In some embodiments of the multiple reference probe design, multiple reference probes are designed to be similar to the single reference probe design described above except the second chamber comprises a plurality of reference probes. Specifically, multiple thin hollow tubes are pulled out from one side of the second chamber to provide a plurality of reference probes. Each reference probe is filled with the same electrolyte gel that is contained within the second chamber and each reference probe comprises a porous frit at the tip of the probe.

In some embodiments, the hollow tubes share a single Ag/AgCl planar electrode that is embedded inside the first chamber. The multiple probes find use in simultaneously providing multiple independent measurement chambers or target objects with a reference potential.

For example, e.g., as shown in FIG. 2A, embodiments provide a second chamber 220 comprising a plurality of reference probes 260. As shown in FIG. 2A and FIG. 2B, embodiments of the technology provide a double junction reference electrode 200 comprising a first chamber 210, a second chamber 220, and a substrate 230. The first chamber 210 is deposited on the surface of the substrate 230, and the second chamber 220 is deposited on the surface of the substrate 230. Further, the first chamber 210 and second chamber 220 are deposited side by side on the surface of the substrate 230. In some embodiments, the plurality of reference probes finds use in measuring analytes in a plurality of samples 900 as shown in FIG. 2B and discussed further below.

The first chamber 210 and the second chamber 220 comprise outer walls. An inner wall 280 (comprising a first frit 250) separates the first chamber 210 from the second chamber 220. The outer walls of the first chamber 210, the inner wall 280, and the substrate 230 define a volume of the first chamber. The outer walls of the second chamber 220, the inner wall 280, and the substrate 230 define a volume of the second chamber 220. The inner wall 280, the outer walls, and the substrate 230 comprise one or more impermeable and unreactive material(s) that do not allow passage and/or allow minimal passage of materials (e.g., gases, liquids, ions, or nonionic species) across (e.g., through) the inner wall 280, the outer walls, and the substrate 230 and that are minimally reactive and/or unreactive with materials (e.g., in a sample, a first electrolyte, and/or a second electrolyte as discussed below) they contact.

A planar electrode 240 is formed on the substrate 230 within the first chamber 210. The first chamber 210 comprises a first electrolyte solution (e.g., a gel electrolyte) and the second chamber 220 (comprises a second electrolyte solution (e.g., a gel electrolyte). Thus, the planar electrode 240 is in electrical communication with the first electrolyte. The inner wall 280 comprises a first frit 250 that separates the first chamber 210 and the second chamber 220. The first frit 250 minimizes and/or eliminates (e.g., substantially and/or effectively eliminates) mixing of the first electrolyte solution with the second electrolyte solution while allowing ionic conductivity between the first electrolyte solution and the second electrolyte solution. Thus, the first electrolyte solution and the second electrolyte solution are in electrical communication.

The second chamber 220 comprises a plurality of reference probes 260. In some embodiments, each reference probe 260 is a hollow, thin tube or needle. Each reference probe 260 has a proximal end connected with and in liquid communication with the second chamber 220, and each reference probe 260 has a distal end. Thus, each reference probe 260 comprises the second electrolyte solution. That is, the second chamber 220 and the plurality of reference probes 260 comprise a volume of a second electrolyte (e.g., a gel electrolyte). Each distal end of each reference probe 260 comprises a second frit 270. The plurality of second frits 270 collectively separates the second chamber 220 and the sample. The plurality of second frits 270 minimizes and/or eliminates (e.g., substantially and/or effectively eliminates) mixing of the second electrolyte solution with the sample while allowing ionic conductivity between the second electrolyte solution and the sample. In some embodiments, each distal end of each reference probe 260 comprises a tapered end that facilitates insertion of each reference probe 260, and thus facilitates insertion of the plurality of reference probes 260 collectively, into a sample. Each distal end of each reference probe 260 comprises a sensing element 290. Each reference probe 260 may independently comprise a different type of sensing element 290, e.g., for measuring a different analyte. In some embodiments, all reference probes 260 of the plurality of reference probes 260 comprise the same type of sensing element 290, e.g., for measuring the same analyte in a plurality of samples.

In some embodiments of the multiple reference probe design, multiple independent double junction reference electrodes (e.g., comprising independent reference probes) similar to the single reference probe design described above are provided on a single substrate. The multiple probes find use in simultaneously providing multiple independent measurement chambers or target objects with a reference potential.

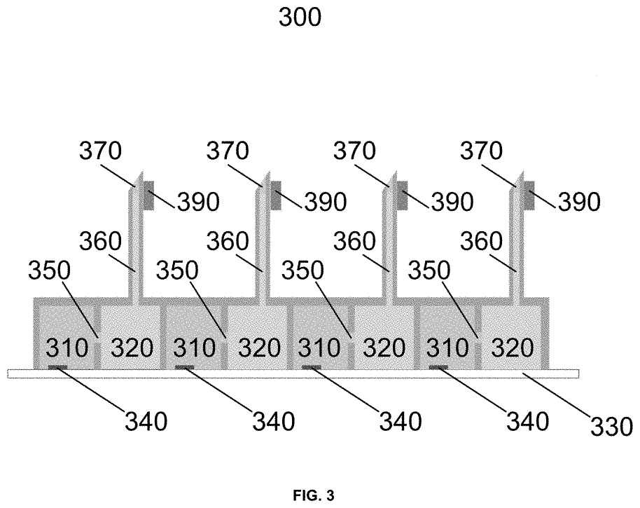

For example, in some embodiments, e.g., as shown in FIG. 3, the technology provides a multi reference probe design in which a plurality of double junction reference electrodes 300 is provided on a unitary substrate. As shown in FIG. 3, in some embodiments, a plurality of first chambers 310 and a plurality of second chambers 320 are provided on the unitary substrate 330. A first chamber 310 separated by a second chamber 320 by a first frit 350 provides a “pair of first chambers 310 and second chambers 320” in which the first chamber 310 and the second chamber 320 are associated with one another. Each double junction reference electrode 300 comprises a pair of first chambers 310 and second chambers 320 and in each pair of first chambers 310 and second chambers 320 a first chamber 310 and a second chamber 320 are associated with one another.

Each double junction reference electrode 300 is separated by a neighboring double junction reference electrode 300 by at least one outer wall. Some double junction reference electrodes 300 are separated by neighboring double junction reference electrodes 300 by two, three, or four outer walls depending on the arrangement of the double junction reference electrodes on the unitary substrate 330.

The plurality of first chambers 310 is deposited on the surface of the unitary substrate 330, and the plurality of second chambers 320 is deposited on the surface of the unitary substrate 330. Further, each first chamber 310 and each second chamber 320 of each double junction reference electrode are deposited side by side on the surface of the unitary substrate 330. This arrangement provides a plurality of double junction reference electrodes 100 as shown in FIG.1 arranged on the unitary substrate as shown in FIG. 3. Each of the plurality of double junction reference electrodes may function independently of the other double junction reference electrodes. The unitary substrate may comprise a PCB comprising a plurality of circuits and each circuit of the plurality of circuits may be in electrical communication with one of the plurality of double junction reference electrodes.

As shown in FIG. 3, each first chamber 310 and each second chamber 320 comprise a number of outer walls. Each pair of first chambers 310 and second chambers 320 comprises an inner wall 380 (comprising a first frit 350) that separates the first chamber 310 from the second chamber 320 in each pair of first chambers 310 and second chambers 320 of each double junction reference electrode. As shown in FIG. 3, outer walls separate each double junction reference electrode from the environment, a sample, or from neighboring double junction reference electrodes. The outer walls of each first chamber 310, each inner wall 380, and the unitary substrate 330 define a volume of the first chamber. The outer walls of each second chamber 320, each inner wall 380, and the unitary substrate 330 define a volume of the second chamber 320. Each inner wall 380, the outer walls, and the unitary substrate that do not allow passage and/or allow minimal passage of materials (e.g., gases, liquids, ions, or nonionic species) across (e.g., through) the inner wall 380, the outer walls, and the substrate 330 and that are minimally reactive and/or unreactive with materials (e.g., in a sample, a first electrolyte, and/or a second electrolyte as discussed below) they contact.

Each first chamber 310 comprises a planar electrode 340 formed on the unitary substrate 330. Each first chamber 310 comprises a first electrolyte solution (e.g., a gel electrolyte) and each second chamber 320 comprises a second electrolyte solution (e.g., a gel electrolyte). Embodiments provide that each of the first electrolyte solutions in each first chamber 310 may be the same or different from the first electrolyte solutions in other first chambers 310. Further, embodiments provide that each of the second electrolyte solutions in each second chamber 320 may be the same or different from the second electrolytes solutions in other second chambers 320.

Thus, each planar electrode 340 is in electrical communication with a first electrolyte. Each inner wall 380 comprises a first frit 350 that separates each first chamber 310 from each associated second chamber 320 in a pair of first chambers 310 and second chambers 320 forming each double junction reference electrode 300 of the plurality of double junction reference electrodes. Each first frit 350 minimizes and/or eliminates (e.g., substantially and/or effectively eliminates) mixing of a first electrolyte solution with a second electrolyte solution separated by the frit 350 while allowing ionic conductivity between the first electrolyte solution and the second electrolyte solution for each pair of first chambers 310 and second chambers 320 forming a double junction reference electrode 300. Thus, a first electrolyte solution and a second electrolyte solution separated by an inner wall 380 and frit 350 are in electrical communication with each other.

Each second chamber 320 comprises an associated reference probe 360. In some embodiments, each reference probe 360 is a hollow, thin tube or needle. Each reference probe 360 has a proximal end connected with and in liquid communication with the associated second chamber 320, and the reference probe 360 has a distal end. Thus, each reference probe 360 comprises a second electrolyte solution. That is, each second chamber 320 and the associated reference probe 360 comprise a volume of a second electrolyte (e.g., a gel electrolyte). The distal end of each reference probe 360 comprises a second frit 370. Each second frit 370 separates each second chamber 320 and the sample. Each second frit 370 minimizes and/or eliminates (e.g., substantially and/or effectively eliminates) mixing of each second electrolyte solution with the sample while allowing ionic conductivity between each second electrolyte solution and the sample. In some embodiments, each distal end of each reference probe 360 comprises a tapered end that facilitates insertion of each reference probe 360 into a sample. Each distal end of each reference probe 360 comprises a sensing element 390. Each reference probe 360 may independently comprise a different type of sensing element 390, e.g., for measuring a different analyte. In some embodiments, all reference probes 360 of the plurality of reference probes 360 comprise the same type of sensing element 390, e.g., for measuring the same analyte in a plurality of samples.

### Probe Arrangements

Thus, the technology provides a double junction reference electrode comprising a plurality of reference probes, e.g., as shown in FIG. 2A, FIG. 2B, and/or FIG. 3. In some embodiments, the double junction reference electrode(s) comprise(s) 2, 3, 4, 5, 6, 7, 8, 9, 10, 11, 12, 13, 14, 15, 16, 17, 18, 19, or 20 or more reference probes. In some embodiments, the double junction reference electrode comprises 30, 40, 50, 60, 70, 80, 90, or 100 or more reference probes. In some embodiments, the double junction reference electrode comprises 100, 200, 300, 400, 500, 600, 700, 800, 900, or 1000 or more reference probes. In some embodiments, the double junction reference electrode comprises 1000, 2000, 3000, 4000, 5000, 6000, 7000, 8000, 9000, or more reference probes. The plurality of reference probes and the arrangements thereof as described herein may be used for both the multi probe design shown in FIG. 2A and FIG. 2B equally as well as to the multi probe design shown in FIG. 3.

In some embodiments, the plurality of reference probes is provided in a linear array. In some embodiments, the plurality of reference probes is provided in a two-dimensional array comprising a number of rows and columns. In some embodiments, the plurality of reference probes is provided in another geometrical arrangement such as a plurality of concentric circles, a hexagonal array, or other shape.

In some embodiments, the technology finds use in providing a plurality of reference probes into the same sample at different locations. In some embodiments, e.g., as shown in FIG. 2B, the technology finds use in measuring one or more analytes in a plurality of samples (e.g., 1 ton integral number of samples (e.g., 1, 2, 3, 4, 5, 6, 7, 8 or more samples)).

In some embodiments, the plurality of reference probes is provided in an arrangement appropriate for insertion into samples provided in the wells of a multi-well plate. As used herein, the term “multiwell plate” refers to one or more addressable wells located on a substantially flat surface. For instance, in some embodiments a multiwell plate comprises a two-dimensional array of addressable wells located on a substantially flat surface. Multiwell plates may comprise any number of discrete addressable wells and comprise addressable wells of any width or depth. The Society for Laboratory Automation and Screening has published recommended standard microplate specifications for a variety of plate formats (see, e.g., the ANSI/SLAS standards ANSI/SLAS 1-2004: Microplates—Footprint Dimensions; ANSI/SLAS 2-2004: Microplates—Height Dimensions; ANSI/SLAS 3-2004: Microplates—Bottom Outside Flange Dimensions; ANSI/SLAS 4-2004: Microplates—Well Positions; and ANSI/SLAS 6-2012: Microplates—Well Bottom Elevation (Either singularly, or as a whole) provided at www.slas.org/education/ansi-slas-microplate-standards); the entirety of each of these recommended specifications is hereby incorporated herein by reference. In some embodiments, wells are arranged in two-dimensional linear arrays on the multiwell plate. However, the wells can be provided in any type of array, such as in a geometric or in a non-geometric array. The multiwell plate can comprise any number of wells. Larger numbers of wells or increased well density can also be easily accommodated. Commonly used numbers of wells include 6, 8, 12, 24, 96, 384, 1536, 3456, and 9600. In various embodiments, the wells are placed in a configuration so that the well center-to well-center distance is between approximately 0.5 millimeters and approximately 100 millimeters. In various embodiments, the wells are placed in any configuration, such as a linear-linear array, or geometric patterns, such as hexagonal patterns.

Accordingly, the technology provides a double junction reference electrode comprising a plurality of reference probes for measuring samples in a multiwell plate. Thus, embodiments provide that the plurality of reference probes is arranged such that each reference probe is positioned to contact the approximate center of a sample provided in a well of a multiwell plate. In some embodiments, reference probes are arranged in a two-dimensional linear array to match a two-dimensional array of a multiwell plate. In some embodiments, the two-dimensional array of reference probes comprises 6, 8, 12, 24, 96, 384, 1536, 3456, or 9600 reference probes arranged to match a two-dimensional array of a multiwell plate. In various embodiments, the reference probes are placed in a configuration so that the distance between the distal ends of the reference probes is approximately 0.5 millimeters to approximately 100 millimeters as appropriate for the particular multiwell plate for which the double junction reference electrode is designed.

### Systems

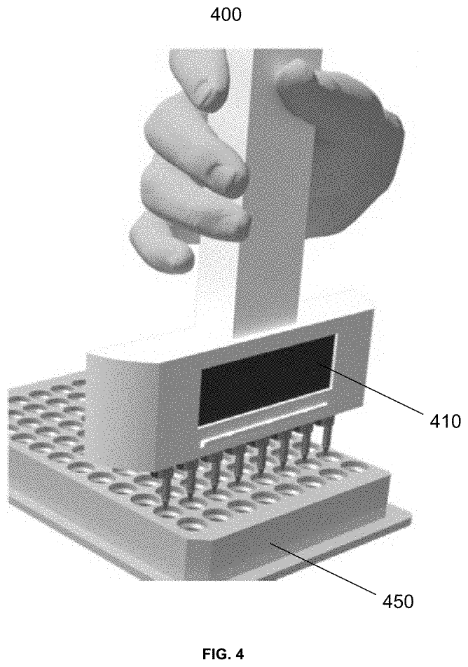

In some embodiments, the technology provides an electroanalytical system, e.g., as shown in FIG. 4. For example, in some embodiments, the technology provides an electroanalytical system comprising a multiple reference probe device as described above and a microchip or computer. In some embodiments, the electroanalytical system comprises a display to provide information to a user. In some embodiments, the electroanalytical system comprises a power source (e.g., a voltage source) such as a battery. In some embodiments, the electroanalytical system comprises a power source (e.g., a voltage source) that is an alternating current voltage or a direct current voltage. In some embodiments, the electroanalytical system comprises an analog to digital converter that receives analog signals from the multiple reference probe device as described above and provides digital signals to a microchip or computer.

In some embodiments, systems comprise a double junction reference electrode as provided herein and a multiwell plate as described herein.

In some embodiments, the electroanalytical system is designed as an integrated device 400 comprising the electroanalytical system comprising a multiple reference probe device as described above (e.g., as shown in FIG. 2A or FIG. 3), a microchip or computer, a power source, and a display 410 to provide information to a user. In some embodiments, the integrated device 400 is an integrated device designed to be manipulated by a human hand and in some embodiments the integrated device 400 is designed to be manipulated by a motorized robotic platform (e.g., a robotic manipulator).

In some embodiments, the integrated device comprises a component for communications over a wired or wireless network and provides information to a mobile device (e.g., a tablet and/or a phone comprising a component for communications over a wireless network). In some embodiments, a user receives results on a mobile device. In some embodiments, a user controls the integrated device using a mobile device. In some embodiments, a user controls the integrated device using a wired controller.

In some embodiments, an integrated device comprises a button or switch for use by a user to obtain a measurement of an analyte in a sample. In some embodiments, the integrated device finds use in performing a number of measurements of a number of analytes in a number of samples, e.g., samples as provided in the wells of a multiwell plate 450. In some embodiments, the integrated device comprises a permanent (e.g., non-consumable) reference electrode and a consumable working electrode (e.g., sensing element). In particular, in some embodiments, the working electrodes are consumables and designed as plug-and-play components that are set to be replaced after a designated number of measurements (e.g., 5, 6, 7, 8, 9, 10, 11, or 12 or more) to maximize accuracy of the measurements. In some embodiments, the connections between the probes and the main part of the device are provided by a snap-lock design for easy replacement and trouble-free installation.

In some embodiments, the integrated device provides a tool to automate ion sensing workflows, e.g., in soil and plant testing labs. In particular, embodiments of the technology provide an integrated device that may be used to perform parallel measurements of ion concentrations in a set of samples (e.g., provided in a multi-well plate). In some embodiments, the individual output voltage signals from each probe are multiplexed and provided as input into an electronic circuit. In some embodiments, the probe-to-probe spacing of the integrated device is adjustable to match the well-to-well spacing of different formats of multi-well plates. Further, the distal ends of the individual probes are of an appropriate size to fit the dimensions of standard multi-plate wells.

In some embodiments, the integrated device comprises a case (e.g., a plastic case) to house a power source, electric circuits, a wireless communications component, and/or the chambers and substrate of a multiple reference probe device as described herein. In some embodiments, plastic (e.g., a thermoplastic) modeling processes are used to manufacture a case and probe bases of the sensor.

### Samples

The technology is not limited in the types of samples that may be tested using embodiments of the double junction reference electrode described herein. For example, in some embodiments, a sample is and/or comprises a plant, plant part, plant tissue, or a plant fluid (e.g., a sap (e.g., phloem sap, xylem sap), apoplastic fluid, etc.) In some embodiments, the sample is or comprises water. In some embodiments, the sample is soil. In some embodiments, the sample is manure. In some embodiments, the sample is a fruit.

### Methods

The technology provides embodiments of methods, e.g., methods of using an embodiment of the double junction reference electrode described herein to measure an analyte in a sample. In some embodiments, methods comprise providing a double junction reference electrode described herein and contacting the double junction reference electrode to a sample. In some embodiments, providing the double junction reference electrode comprises manufacturing a double junction reference electrode (e.g., according to a method as described herein or according to another method) or having manufactured by another a double junction reference electrode (e.g., according to a method as described herein or according to another method). In some embodiments, methods comprise contacting the double junction reference electrode to a plant, plant part, plant tissue, or a plant fluid (e.g., a sap (e.g., phloem sap, xylem sap), apoplastic fluid, etc.); water; soil; manure; or a fruit. In some embodiments, contacting a sample comprises inserting a reference probe into the sample.

In some embodiments, methods comprise providing a current or a voltage from the double junction reference electrode. In some embodiments, methods provide a coulometric assay, an amperometric assay, a potentiometric assay, an electrochemical impedance spectroscopy-based assay, and/or a voltammetric assay. In some embodiments, methods comprise providing a current, a voltage, or an electrochemical impedance to an electric circuit in electrical communication with the double junction reference electrode. In some embodiments, methods comprise providing an analog and/or digital signal to a computer comprising software for analyzing, transforming, and/or displaying information related to the analog and/or digital signal. In some embodiments, a computer displays a test result to a user.

In some embodiments, methods comprise converting an analog electric signal (e.g., a voltage, a current, or an electrochemical impendance) into a digital signal (e.g., using an analog to digital converter). In some embodiments, methods comprise using the analog or digital signal to provide a measurement (e.g., an amount or concentration of an analyte) to a user. In some embodiments, methods comprise obtaining a series of measurements over a time interval (e.g., over a period of seconds, minutes, hours, days, weeks, months, or years). In some embodiments, methods comprise obtaining 1 measurement to several millions of measurements during a time interval. In some embodiments, methods comprise obtaining 1, 2, 3, 4, 5, 6, 7, 8, 9, 10, 20, 30, 40, 50, 60, 70, 80, 90, 100, 200, 300, 400, 500, 600, 700, 800, 900, or 1000 or more measurements during a time interval. In some embodiments, methods comprise obtaining a measurement from a sample that is a positive control (e.g., a sample comprising a known amount or concentration of an analyte). In some embodiments, methods comprise obtaining a measurement from a sample that is a negative control (e.g., a sample comprising no analyte (e.g., an analyte-free sample, substantially analyte-free sample, and/or essentially analyte-free sample), e.g., a sample comprising undetectable analyte). In some embodiments, methods comprise comparing one or more test results to a measurement obtained from a positive control and/or to a measurement obtained from a negative control.

In some embodiments, methods comprise transmitting an analog signal or a digital signal. In some embodiments, methods comprise transmitting a test result. In some embodiments, methods comprise transmitting an analog signal, a digital signal, and/or a test result over a network, e.g., over a wireless or wired network. In some embodiments, methods comprise transmitting an analog signal, a digital signal, and/or a test result to a device (e.g., a handheld device) for display to a user. In some embodiments, methods comprise transmitting an analog signal, a digital signal, and/or a test result to a computer for transformation, display, calculation, and/or storage (e.g., in a database).

In some embodiments, methods comprise obtaining multiple measurements in parallel using an embodiment of a multiple reference probe device described herein. In some embodiments, methods comprise obtaining multiple measurements in parallel using an embodiment of a handheld integrated device described herein. In some embodiments, obtaining multiple measurements in parallel comprises obtaining multiple measurements of the same analyte in different samples. In some embodiments, obtaining multiple measurements in parallel comprises obtaining multiple measurements of the same analyte in the same sample (e.g., in different locations in the same sample). In some embodiments, obtaining multiple measurements in parallel comprises obtaining measurements of different analytes in different samples. In some embodiments, obtaining multiple measurements in parallel comprises obtaining measurements of different analytes in the same sample. For example, some embodiments of methods comprise providing a multiwell plate comprising a plurality of samples in the wells of the multiwell plate, simultaneously (e.g., substantially and/or effectively simultaneously) contacting the plurality of samples with a plurality of reference probes provided by a device comprising one or more double junction reference electrode(s) as described herein (e.g., provided by a handheld integrated device as described herein), and obtaining a plurality of test results for one or more types of analytes.

Embodiments of the technology may be operated with or without applying a potential to the double junction reference electrode and/or sensing element. In some embodiments, the electrochemical reaction occurs spontaneously and a potential is not necessarily applied between the sensing element and double junction reference electrode. In some embodiments, a potential is applied between the double junction reference electrode and/or sensing element. The potential may be constant or it may vary. Thus, in some embodiments, methods comprise applying a potential (e.g., a constant or varying potential) between the sensing element and double junction reference electrode and, in some embodiments, methods comprise not applying a potential between the sensing element and double junction reference electrode.

Steps of methods described herein may be performed by a human and/or by a motorized robotic device having been programmed by a human and/or under control by a human. Thus, a human may perform one or more steps, a human may have performed one or more steps by another human and/or by a motorized robotic device, and/or a human may provide a computer (e.g., comprising software for performing one or more method steps) that instructs a motorized robotic platform to perform an embodiment of a method.

### Kits

Embodiments of kits for use in practicing the subject technology are also provided. The subject kits may include one or more double junction reference electrodes as described herein. The kits may further include one or more additional components necessary for carrying out a method for measuring an analyte, e.g., control reagents, sample containers, and the like. As such, the kits may include one or more containers such as vials or bottles, with each container containing a separate component for the assay.

In addition to one or more double junction reference electrodes, kits may also include written instructions for using a double junction reference electrode to contact a sample with a reference probe for use in an analyte determination assay. Particular instructions may describe insertion of a reference probe into a plant or plant part for an in vivo (in planta) assay of nitrate concentration. The instructions may be printed on a substrate, such as paper or plastic, etc. As such, the instructions may be present in the kits as a package insert, in the labeling of the container of the kit or components thereof (e.g., associated with the packaging or sub-packaging). In some embodiments, the instructions are present as an electronic storage data file present on a suitable computer readable storage medium, e.g., CD-ROM, diskette, etc. In some embodiments, the actual instructions are not present in the kit, but means for obtaining the instructions from a remote source, e.g., via the Internet, are provided. An example of this embodiment is a kit that includes a web address where the instructions can be viewed and/or from which the instructions can be downloaded. As with the instructions, this means for obtaining the instructions is recorded on a suitable substrate.

In some embodiments of kits, the components of the kit are packaged in a kit containment element to make a single, easily handled unit, where the kit containment element, e.g., a box or analogous structure, may or may not be an airtight container, e.g., to further preserve the one or more sensors and additional reagents (e.g., control solutions), if present, until use.

### Uses

In some embodiments, the technology described herein finds use in measure an analyte (e.g., ion) concentration, e.g., an anion such as nitrate. Conventional methods for testing nitrate concentrations (e.g., by commercial laboratories) are time consuming, inefficient, and often produce toxic waste containing cadmium. In contrast, the technology described herein provides embodiments of a technology for sensing ions such as nitrate that eliminate and/or minimize toxic reagents and heavy metal waste while reducing labor and overall cost.

Embodiments of the technology provide a technology for measuring nitrate that finds use in automated testing and analysis that is similar to conventional laboratory pH testing. In particular, conventional lab-based pH testing is electrode-based and uses technologies similar to the electrode sensor using the double junction reference electrode technology described herein. The electrode based pH testing system allows soil and plant testing labs to measure soil pH robotically without preparing reagents, without producing toxic waste, and without tediously maintaining flow-injection analytical machines that rely on mixing multiple solutions to measure a sample. Similarly, the technology provided herein may be automated to allow soil and plant testing labs to measure plant nitrate levels robotically. Further, electrode-based measurement eliminates filtration steps that are often used to prepare samples. In particular, instead of mixing a solid (e.g., a plant, plant part, or soil) with a solution, filtering it, and then measuring nitrate according to some conventional methods, the methods and technologies described herein may comprise mixing a sample in a 1:1 0.01 M CaCl₂ solution and measuring an ion (e.g., nitrate) with the electrode without filtration. Accordingly, the sensor technology reduces the time required for measurements, reduces costs, and reduces production of wastes.

Although the disclosure herein refers to certain illustrated embodiments, it is to be understood that these embodiments are presented by way of example and not by way of limitation.

### EXAMPLES

### Example 1

### Measurement Accuracy and Error

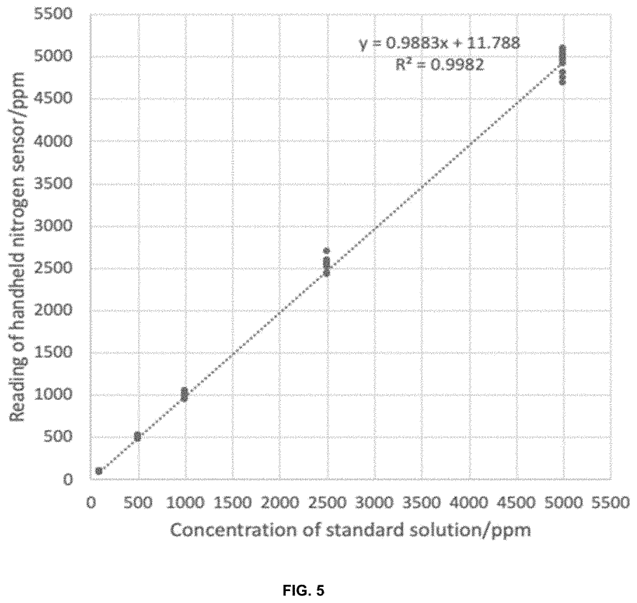

During the development of embodiments of the technology described herein, experiments were conducted to test the measurement accuracy of a nitrate-selective electrode sensor using the double junction reference electrode technology described herein. The sensor was used to test standard solutions of 100, 500, 1000, 2500, and 5000 ppm NO3-N that were prepared by dissolving potassium nitrate (KNO₃) into deionized water. Ten measurements were performed for each standard solution. The data collected during the experiment indicated that the nitrate-selective electrode sensor using the double junction reference electrode technology described herein provided accurate readings of nitrate concentration in the standard solutions (FIG. 5). Statistical analysis of the data collected during the experiment indicated that the measurement error of the nitrate-selective electrode sensor using the double junction reference electrode technology described herein falls within ±4.5% (Table 1).

TABLE 1
double junction reference electrode measurement error

| | Standard solution nitrate concentration (ppm) | | | | |
|---|---|---|---|---|---|
| | 100 | 500 | 1000 | 2500 | 5000 |
| Average of 10 | 95.5 | 493.7 | 999.5 | 2538.9 | 4926.5 |
| measurements (ppm) | | | | | |
| Measurement error | 4.5 | 1.26 | 0.05 | 1.55 | −1.47 |
| (%) | | | | | |

### Example 2

### Effect of Temperature

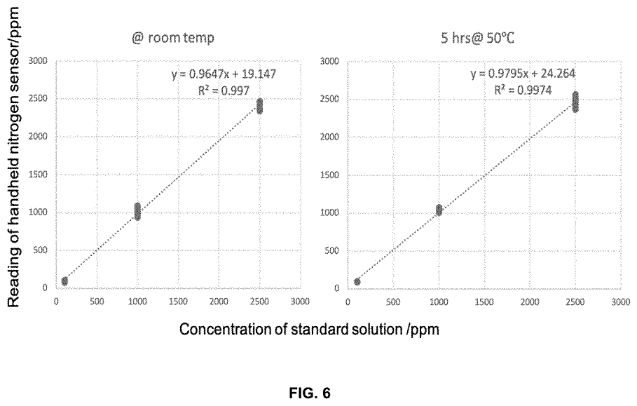

During the development of embodiments of the technology described herein, experiments were conducted to test the effect of temperature on the nitrate-selective electrode sensor using the double junction reference electrode technology described herein. The sensor was used to test standard solutions of 100, 1000, and 2500 ppm NO₃-N were at room temperature (FIG. 6, left plot) and at 50° C. (FIG. 6, right plot). The data collected during the experiment indicated that the performance of the nitrate-selective electrode sensor using the double junction reference electrode technology described herein is not affected by a high environmental temperature (e.g., 50° C.).

### Example 3

### Effect of Chloride Ion

During the development of embodiments of the technology provided herein, experiments were conducted to test the effect of a second ion (e.g., chloride) on measurement of nitrate using the nitrate-selective electrode sensor using the double junction reference electrode technology described herein. The sensor was used to test standard solutions of 0, 100, 500, 1000, 2500, 5000 ppm NO₃-N comprising chloride ion at 0, 5, 10, 25, 50, or 100 ppm. Thus, a matrix of 36 samples was tested (6 nitrate concentrations×6 chloride concentrations). Table 2 shows the correlation coefficient between the measured nitrate concentration and the actual nitrate in the prepared mixture of chloride ion and standard nitrate ion solutions.

TABLE 2
Effect of chloride ion

| | Chloride (Cl⁻] ion concentration (ppm) added | | | | | |
|---|---|---|---|---|---|---|
| | into standard nitrate solutions of 0, 100, 500, | | | | | |
| | 1000, 2500, and 5000 ppm NO₃—N | | | | | |
| | 0 | 5 | 10 | 25 | 50 | 100 |
| Correlation coefficient | 0.99923 | 0.99745 | 0.99749 | 0.99735 | 0.99619 | 0.99732 |
| between the measured nitrate | | | | | | |
| concentration and the real | | | | | | |
| nitrate level in the mixture of | | | | | | |
| chloride ion and standard | | | | | | |
| nitrate ion solutions | | | | | | |

### Example 4

### In Vivo/in Planta Measurement

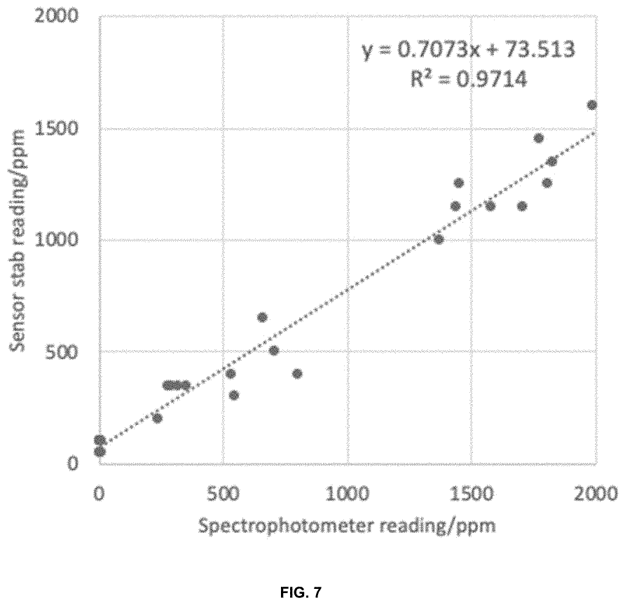

During the development of embodiments of the technology provided herein, experiments were conducted to measure nitrate in the stalk of a maize plant. The probe of a nitrate-selective electrode sensor using the double junction reference electrode technology described herein was inserted into the stalk of maize plant for in-situ measurement of stalk nitrate concentration. The measurement was conducted in a greenhouse. Thirty maize plants were planted and divided into three groups of ten plants. For group 1, one-third tablespoon of nitrogen fertilizer was added to one 5-gallon pot to create a nitrogen starved environment. For group 2, one-half tablespoon of nitrogen fertilizer was added to one 5-gallon pot to provide a middle range of nitrogen environment. For group 3, one tablespoon of nitrogen fertilizer was added to one 5-gallon pot to create a nitrogen rich environment. All experiments were conducted during V7-8 stage of the maize plants. FIG. 7 shows the comparison of the nitrate concentration measured using a conventional spectrophotometer according to standard methods and the reading obtained using the nitrate-selective electrode sensor using the double junction reference electrode technology described herein.

### Example 5

### Testing a Handheld Integrated Nitrate Sensing Device

In some embodiments, experiments are conducted to test a handheld integrated nitrate sensing device comprising a multi-probe sensor as described herein. These experiments characterize and validate multi-probe sensors using the same protocols as those used for testing a single probe sensor. Further, the multi-probe sensor is tested against a conventional method of plant nitrate testing that uses a 2% solution of acetic acid to extract plant tissue. Experiments are conducted to test samples from plants including corn, potatoes, sugar beets, and other high-value horticultural crops. Results are compared on the basis of simple correlations among the data collected with the two methods as well as the time and cost savings.

All publications and patents mentioned in the above specification are herein incorporated by reference in their entirety for all purposes. Various modifications and variations of the described compositions, methods, and uses of the technology will be apparent to those skilled in the art without departing from the scope and spirit of the technology as described. Although the technology has been described in connection with specific exemplary embodiments, it should be understood that the invention as claimed should not be unduly limited to such specific embodiments. Indeed, various modifications of the described modes for carrying out the invention that are obvious to those skilled in the art are intended to be within the scope of the following claims.

1. A double junction reference electrode comprising:
a substrate; and
a housing attached to the substrate, said housing comprising a first chamber; an inner wall comprising a first frit; and a second chamber comprising a hollow reference probe structure comprising a second frit.

2. The double junction reference electrode of claim 1, wherein said substrate further comprises a planar electrode on a first surface of the substrate positioned within said first chamber.

3. (canceled)

4. The double junction reference electrode of claim 2, wherein the first chamber comprises a first electrolyte in electrical communication with the planar electrode.

5. The double junction reference electrode of claim 4, wherein the second chamber and reference probe comprise a second electrolyte and the first frit allows ionic conductivity between the first electrolyte and the second electrolyte.

6, 7. (canceled)

9. The double junction reference electrode of claim 5, wherein the second frit allows ionic conductivity between the second electrolyte and a sample contacting said reference probe and second frit.

10. The double junction reference electrode of claim 1, wherein said reference probe further comprises an analyte sensing element.

11. The double junction reference electrode of claim 10, wherein said analyte sensing element is a nitrate sensing element.

12. The double junction reference electrode of claim 1, wherein said substrate comprises a printed circuit board (PCB), glass, plastic, silicon, or quartz.

13. The double junction reference electrode of claim 1, wherein said housing is attached to said substrate with an adhesive.

14. The double junction reference electrode of claim 1, wherein said housing comprises a plastic or a metal.

15. The double junction reference electrode of claim 1, wherein said first frit and/or said second frit comprise a plastic or a metal.

16. The double junction reference electrode of claim 1, wherein said first frit and/or said second frit comprise pores having a mean pore size of 0.01 to 50 μm.

17. The double junction reference electrode of claim 4, wherein the first electrolyte is -a-an electrolyte solution comprising potassium chloride saturated with silver chloride.

18. The double junction reference electrode of claim 5, wherein the second electrolyte is a lithium acetate electrolyte.

19. The double junction reference electrode of claim 1, wherein the second chamber comprises a plurality of reference probes and each reference probe comprises a second frit and a sensing element.

20-64. (canceled)

65. A method of detecting an analyte, the method comprising:
providing a double junction reference electrode comprising:
a substrate; and
a housing attached to the substrate, said housing comprising a first chamber;
an inner wall comprising a first frit; and a second chamber comprising
a hollow reference probe structure comprising a second frit; and
contacting said double junction reference electrode to a sample.

66-72. (canceled)

73. The method of claim 65, wherein said sample is a plant, plant part, plant tissue, or a plant fluid; water; soil; manure; or a fruit.

74. The method of claim 65, wherein contacting a sample comprises inserting said reference probe into the sample.

75. The method of claim 65, wherein contacting a sample comprises inserting said reference probe into the sample and leaving the reference probe in contact with the sample for a time period of seconds, minutes, hours, days, weeks, months, or years.

76. A kit comprising:
a double junction reference electrode comprising:
a substrate; and
a housing attached to the substrate, said housing comprising a first chamber;
an inner wall comprising a first frit; and a second chamber comprising
a hollow reference probe structure comprising a second frit; and
a positive or negative control, a vessel for testing a sample, and/or a consumable working electrode.

77, 78. (canceled)
